(19) United States
(12) Patent Application Publication
(10) Pub. No.: US 2019/0020244 A1
(43) Pub. Date: Jan. 17, 2019

(54) DEVICE FOR MONITORING THE AIR GAP OF AN ELECTRIC MACHINE AND METHOD FOR RETROFITTING

(71) Applicant: Voith Patent GmbH, Heidenheim (DE)

(72) Inventors: Achim Frank, Illerberg (DE); Markus Adam, Heidenheim (DE); Dirk Emmrich, Giengen (DE); Stefan Lahres, Aalen (DE)

(73) Assignee: Voith Patent GmbH, Heidenheim (DE)

(21) Appl. No.: 16/132,958

(22) Filed: Sep. 17, 2018

Related U.S. Application Data
(63) Continuation of application No. PCT/EP2017/054870, filed on Mar. 2, 2017.

(30) Foreign Application Priority Data
Mar. 17, 2016 (DE) 10 2016 204 406.0

(51) Int. Cl. H02K 11/20; G01S 13/88; H02K 11/35; H01Q 13/08

(52) U.S. Cl. CPC H02K 11/20; H01Q 13/085; H02K 11/35; G01S 13/88

(57) ABSTRACT

A device for monitoring the air gap of an electric machine and method for retrofitting. Electric machine, including a rotor, a stator with a laminated core and a device for monitoring the radial air gap of the electric machine, wherein the device includes a microwave radar system which includes a transmission and receiving unit for transmitting and receiving microwaves, an antenna and a cable connecting the transmission and receiving unit with the antenna, wherein antenna during operation of the device is arranged such that its opening terminates with one side of the radial gap that is to be monitored.

### CROSS REFERENCE TO RELATED APPLICATIONS

This is a continuation of PCT application No. PCT/EP2017/054870, entitled “DEVICE FOR MONITORING THE AIR GAP OF AN ELECTRIC MACHINE AND METHOD FOR RETROFITTING”, filed Mar. 2, 2017, which is incorporated herein by reference.

### BACKGROUND OF THE INVENTION

### 1. Field of the Invention

The current invention relates to a device for monitoring the air gap of a large electric machine, for example a generator or motor-generator for a hydroelectric power plant. The invention moreover relates to a method for retrofitting an existing electric machine including such a device.

### 2. Description of the Related Art

Devices for monitoring the air gap of a large electric machine, in other words the radial gap between the rotor and the stator of such an electric machine are known from the current state of the art. We refer you in this context to WO 01/47092 A1. Devices of this type normally use capacitive sensors for monitoring of the air gap. See description for example in DE 10 2014 202 695 A1.

The use of capacitive sensors entails a number of disadvantages. Capacitive sensors having air gaps larger than 10 mm present relatively large measuring errors, so that with air gaps or greater than 50 mm, such sensors can no longer be used. Capacitive sensors are moreover relatively large scale, so that their use often inhibits the flow of the cooling medium; for example because the sensors block several openings for cooling air intake. Capacitive sensors are furthermore sensitive to contamination (of the sensor or of the rotor poles), since due to this the measured value can be altered. Retrofitting of these capacitive sensors is very expensive, especially if they are to be installed in the center of the machine, disassembly of a pole or even of the complete rotor becomes necessary.

It is the objective of the current invention to remedy the aforementioned disadvantages.

### SUMMARY OF THE INVENTION

The present invention provides a microwave radar system used as the sensor to precisely determine the width of the air gap. The radar system includes a transmission and receiving unit and an antenna. Microwaves produced by the transmission and receiving unit are fed to the antenna. The antenna is arranged such that its opening, that is to say the end of the antenna that emits and receives the radiation terminates flush with the one side of the air gap, so that microwaves emerging from the opening of the antenna cross the air gap in radial direction and are reflected from the opposite side of the air gap. The reflection signal is received by the antenna and is transmitted to the transmission and receiving unit. From this, the width of the air gap can be determined.

The microwave radar system can herein be arranged on either the rotor or the stator. For complete capture of all statistical values associated with the air gap (for example eccentricity, ovality, incline of the axis, etc.) several sensors that are arranged at various locations are required. Thus, a combination of sensors on the rotor and on the sensor are conceivable, whereby most of the sensor are arranged on the stator. (see WO 01/47092 A1).

The suggested radar-based sensors offer higher accuracy than the known capacitive sensors. Moreover, radar-based sensors are not susceptible to contamination. The only limiting condition exists in that the radar signal is only reflected by metallic objects. This is however a given, since the poles of the rotor as well as the interior wall of the stator reflect the radar signals. Since only the opening of the antenna adjoins the air gap and the transmission and receiving unit can be located far from the air gap, cooling of the electric machine is much less impaired than when using capacitive sensors.

An especially advantageous embodiment can be achieved with sensors that are arranged on the stator. In this case, the antenna can be arranged in a ventilation slot and the cable between the transmission and receiving unit and the antenna can be routed in the same ventilation slot. Only one ventilation slot per sensor is hereby blocked. The transmission and receiving unit is thus located outside the stator core and is easily accessible which greatly simplifies routing of the cables from the control or monitoring unit of the electric machine to the transmission and receiving unit. In this case “ventilation slot” is understood to be a channel in the laminated core of the stator that penetrates same in radial direction. Such ventilation slots are generally limited in axial direction by plates of the laminated core of the stator and in circumferential direction by supporting bars.

From the above it is clear that retrofitting an existing machine with such a radar sensor that is arranged on the stator side is especially simple and cost effective, since no access to the space inside the stator core is required and the existing ventilation slots can be used for insertion of the antenna. It may be necessary to reinforce the antenna and the cables leading to the antenna so that the antenna can be inserted into the ventilation slot.

When manufacturing a new electric machine, the antenna and the cables leading to the antenna can be designed as a rigid body with a rectangular cross section. Such a body can replace other structural components of the stator, for example the aforementioned supporting bars. In this case, cooling of the electric machine is in no way negatively affected by the sensors. They can be integrated just as easily into the stator core on any desired other location of same.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows an embodiment of the invention for monitoring the radial air gap in a large electric machine;

FIG. 2 shows an enlarged detail of the embodiment shown in FIG. 1;

FIG. 3 shows a schematic illustration of the device according to an embodiment; and

FIG. 4 shows a flowchart of an embodiment of a method.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

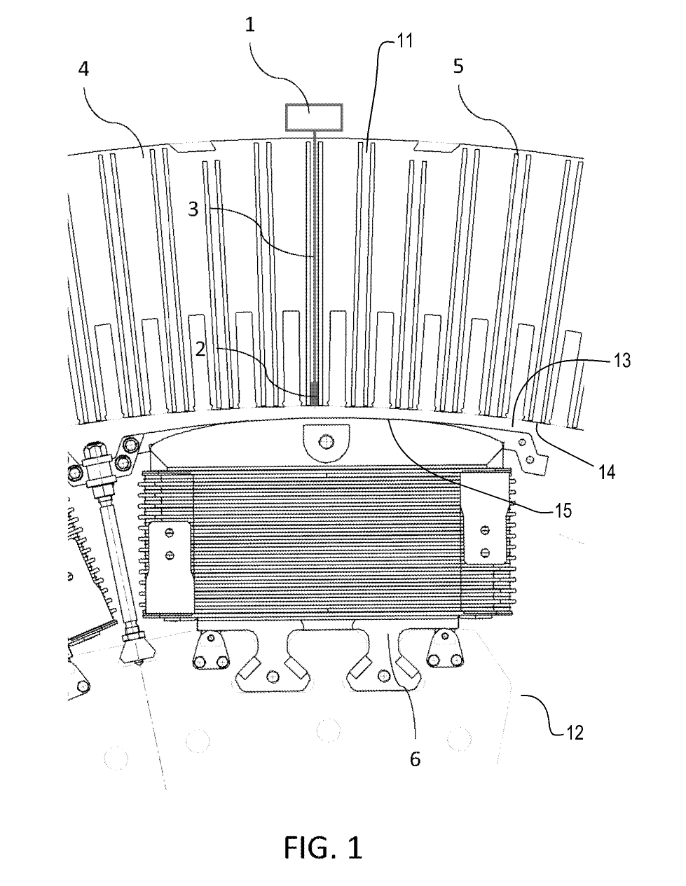

Referring now to the drawings, and more particularly to FIG. 1, there is shown a section of a large electric machine in a sectional view perpendicular relative to the axis of rotation, having an inventive device for monitoring the air gap. The laminated core of the stator 4 has ventilation slots that are located in the laminated core 4. The ventilation slots 11 are normally created in that a multitude of supporting bars 5 are provided in the laminated core of the stator 4. The supporting bars 5 herein progress in radial direction and the ventilation slots 11 progress also radially, wherein one ventilation slot 11 is always bordered respectively in circumferential direction by two supporting bars 5. Located on the outside of the laminated core of stator 4, on the outside edge of same, a transmission and receiving unit 1 of the inventive device is arranged. On the inside edge of the laminated core of stator 4 an antenna 2 is arranged in a ventilation slot 11. The end of the antenna 2 that transmits and receives the radiation terminates flush with the inside edge 14 of the laminated core of stator 4 which forms the one side of the air gap 13 of the electric machine. The other side of the air gap 13 is formed by the outside edge 15 of the rotor 12. On said rotor 12, rotor poles 6 are located. Antenna 2 is connected with transmission and receiving unit 1 by a cable 3.

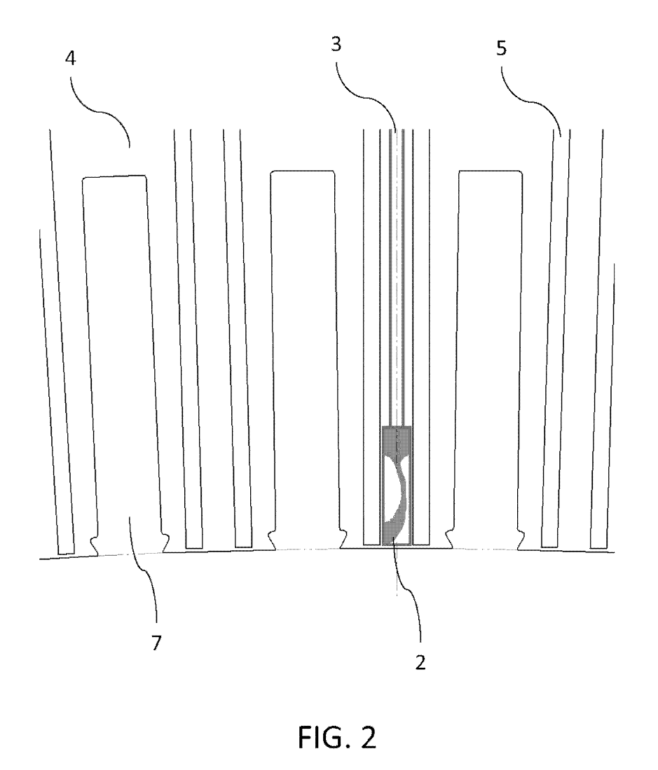

FIG. 2 provides an enlarged detail of laminated core at stator 4 according to FIG. 1. The identifications are consistent with the identifications in FIG. 1. Additionally, a groove 7 is provided in laminated core at stator 4 for accommodation of the stator winding (not shown). It can be seen that antenna 2 is located in the region of a tooth of the laminated core, since only the teeth of the laminated core are adjacent to the air gap 13. In contrast, in the region of a groove 7, the inserted winding would border the air gap 13. Antenna 2 may be in the embodiment of a Vivaldi antenna with extreme broadband capacity. Moreover, due to its design it is very well suited for the current application in regard to the installation situation in the laminated core of stator 4 of the electric machine.

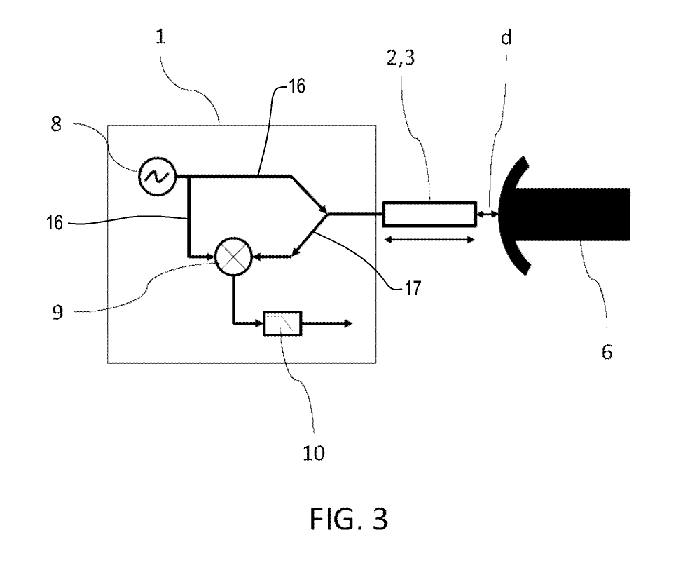

FIG. 3 is a schematic illustration of the present invention. The identifications correspond again with those in FIG. 1. In contrast to FIGS. 1 and 2, antenna 2 and cable 3 form one unit that is identified with 2, 3. This unit is rigid enough that it can be inserted into an air gap 13 in the laminated core of stator 4 of an existing electric machine at a later date in accordance with the inventive method for retrofitting. For reinforcement of the unit 2, 3, embedding into synthetic resin is conceivable. The width d of the air gap 13 that is to be measured is identified in FIG. 3. The double arrow below unit 2, 3 is intended to indicate that this region is located in the laminated core of the stator. Transmission and receiving unit 1 includes an oscillator 8 for the production of microwaves, a mixer 9 and a low-pass 10. The arrows inside transmission and receiving unit 1 indicate schematically the progress of the microwave signals. The microwaves 16 produced in oscillator 8 are fed into unit 2, 3. In other words, they are led via cable 3 into antenna 2. Antenna 2 emits the microwaves into the air gap 13 which are reflected at the outside edge of rotor poles 6. The reflected microwaves are received by antenna 2 and are fed back by cable 3 to transmission and receiving unit 1. There, mixer 9 mixes the microwaves 16 that are produced by the oscillator 8 with the reflected microwaves 17. The signal produced by the mixer subsequently passes low-pass 10. The resulting signal contains the information regarding the air gap 13 width d and can be analyzed with a control or respectively monitoring unit (not illustrated).

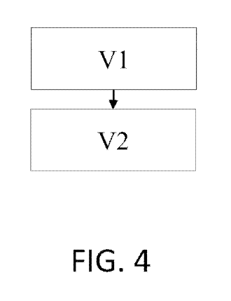

FIG. 4 shows the sequence of the inventive method for retrofitting of an existing electric machine with a device according to the invention. In the process step identified as V1, a device according to the invention is provided wherein unit 2, 3 consisting of cable 3 and antenna 2 have sufficient rigidity, that it can be inserted into a ventilation slot 11 in the laminated core of stator 4. In the process step identified as V2, unit 2, 3 consisting of cable 3 and antenna 2 are inserted into a ventilation slot 11 of the stator until the opening of antenna 2 is flush with the inside edge of laminated core 4. Herein it may be advantageous if unit 2, 3 has the exact length that is consistent with the radial extension of laminated core 4, so that unit 2, 3 cannot be inserted too far into the ventilation slot 11. To achieve this goal, a marking may also be placed on the end of unit 2, 3 that is located opposite antenna 2. Unit 2, 3 is then inserted into the ventilation slot 11 precisely to the point where the marking contacts the outside edge of laminated core of stator 4. Transmission and receiving unit 1 remains therein outside laminated core of stator 4 and is possibly fastened to same.

It is clear that the device according to the invention which is suitable for retrofitting an existing electric machine can be transferred from one ventilation slot 11 to another ventilation slot 11 of the electric machine, if this should prove to be advantageous. Therefore, with such a device the air gap 13 can be measured successively at different locations of the electric machine.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A monitoring device for an electric machine, comprising:
a rotor having an outside edge;
a stator with a laminated core having an inside edge, the rotor outside edge and the stator inside edge forming a radial gap therebetween; and
a microwave radar system including,
a transmission and receiving unit configured for transmitting and receiving microwaves;
an antenna; and
a cable connecting the transmission and receiving unit with the antenna, the antenna being arranged such that its' opening terminates with one side of the radial gap that is to be monitored.

2. The monitoring device according to claim 1, wherein the transmission and receiving unit includes an oscillator configured for the production of microwaves, a mixer and a low-pass.

3. The monitoring device according to claim 1, wherein the antenna is a Vivaldi type of antenna.

4. The monitoring device according to claim 1, wherein the microwave radar system during operation of the monitoring device is arranged on the rotor of the electric machine.

5. The monitoring device according to claim 1, wherein the microwave radar system during operation of the monitoring device is arranged on the stator of the electric machine.

6. The monitoring device according to claim 5, wherein the antenna and the cable form one unit which has sufficient rigidity to be inserted from outside the stator into a ventilation slot of the stator with the laminated core.

7. The monitoring device according to claim 5, wherein the antenna and the cable are arranged in a ventilation slot of the stator with the laminated core, and wherein the transmission and receiving unit is arranged outside the stator with the laminated core.

8. The monitoring device according to claim 5, wherein the antenna and the cable form one unit which has a rectangular cross section.

9. The monitoring device according to claim 8, wherein the unit replaces a support bar of the stator with the laminated core.

10. A method for retrofitting an existing electric machine with a monitoring device, comprising:
providing a rotor having an outside edge;
providing a stator with a laminated core having an inside edge, the rotor outside edge and the stator inside edge forming a radial gap therebetween;
providing a microwave radar system including,
a transmission and receiving unit configured for transmitting and receiving microwaves;
an antenna; and
a cable connecting the transmission and receiving unit with the antenna, the antenna being arranged such that its' opening terminates with one side of the radial gap that is to be monitored, the antenna and the cable forming one unit having sufficient rigidity to be inserted from outside the stator into a ventilation slot of the stator with the laminated core; and
inserting the unit having the cable and the antenna into a ventilation slot of the stator with the laminated core from the outside edge of the stator with the laminated core until the opening of the antenna terminates with the inside edge of the stator with the laminated core (4), the transmission and receiving unit remaining outside the stator with the laminated core.
